(19) United States
(12) Patent Application Publication
(10) Pub. No.: US 2015/0334439 A1
(43) Pub. Date: Nov. 19, 2015

(54) METHOD AND SYSTEM FOR DISPLAYING EVENT MESSAGES RELATED TO SUBSCRIBED VIDEO CHANNELS

(71) Applicant: Thomson Licensig, Issy de Moulineaux (FR)

(72) Inventors: Zhigang ZHANG, Beijing (CN); Jun XU, Beijing (CN); Xiaojun MA, Beijing (CN)

(21) Appl. No.: 14/653,481

(22) PCT Filed: Dec. 24, 2012
(86) PCT No.: PCT/CN2012/087257

§ 371 Date: Jun. 18, 2015

(51) Int. Cl. H04N 21/41; H04N 21/4788; H04N 21/462; H04N 21/235; H04N 21/254

(52) U.S. Cl. CPC H04N 21/4122; H04N 21/235; H04N 21/254; H04N 21/4126; H04N 21/4622; H04N 21/4788

(57) ABSTRACT

A method and an apparatus for receiving and displaying event messages associated with subscribed video channels, in particular television channels received by a set top box, or other television receivers, in a user location. According to the present principles, the user selects one or more channels to be included in a subscription list, which is transmitted to a message server. A second screen device, such as a smartphone, or a tablet, receives and displays event messages associated with television channels on the subscribed list, which are not currently being received, processed and displayed. The event messages may comprise, for example, program descriptions, and comments that are generated by a production company or via social networks. In this manner, a user is able to privately monitor other channels that he may be interested in, without disturbing the viewing by others.

### TECHNICAL FIELD

The present principles relate to an apparatus and a method for receiving and displaying event messages related to a program channel, and in particular, to an apparatus and a method for receiving and displaying event messages related to a television channel on a second display device separate and distinct from a television receiver and display device.

### DESCRIPTION OF RELATED ART

Currently there are systems that allow a viewer of a television channel to be notified of events that may be of interest that is occurring on a different channel. The event messages are received via the same network that the television channel is being received on, and the message is displayed on the same display device on which the currently selected channel is displayed. However, this may be inconvenient for the user, or others viewing the selected channel. Others viewing the program may not be interested in receiving such event messages and the user may wish to view the event messages privately. Therefore, it is desired to provide improvements to the methods for providing event messages to a user.

### SUMMARY OF THE INVENTION

In one implementation, the present principles provide for a method for displaying event messages, comprising the steps of: subscribing to receive event messages associated with one or more television channels; determining a current television channel being received and processed; receiving and displaying event messages associated with subscribed television channels other than the current television channel, wherein the event messages are displayed on a display screen other than a screen displaying the current television channel. The event messages may be received via a transmission channel that is separate from the transmission channel associated with the television channels. The current television channel being received may be determined by an identification transmitted by the television receiver to the display screen, or by using audio fingerprinting methods. By displaying the event messages related to the subscribed television channels, other than the current channel being received and processed, on a second display screen, the user is able to receive and view the event messages separately from the display of the program. Upon changing from the current channel to a newly selected channel, the system changes the list of event messages so that the display of the event messages now are based on the newly selected channel, that is, the system displays the event messages associated with subscribed channels other than the newly selected channel.

Various implementation for subscribing to a set of channels are described, for example, allowing a user to select one of a plurality of subscription lists, each of the subscription lists including a list of subscribed television channels, or accepting a subscription list including a list of subscribed television channels recommended by a friend in a social network, or displaying a list of possible television channels for subscription, receiving user input of selected ones of the possible television channels, and transmitting the user selected ones of the possible television channels to a message server. The displaying of event messages may be performed on one of a smart phone, tablet computer and remote control device.

In another implementation, the present principles provide for an apparatus and/or a system for performing the steps of the method described above.

The details of one or more implementations are set forth in the accompanying drawings and the description below. Even if described in one particular manner, it should be clear that implementations may be configured or embodied in various manners. For example, an implementation may be performed as a method, or embodied as an apparatus, such as, for example, an apparatus configured to perform a set of operations or an apparatus storing instructions for performing a set of operations, or embodied in a signal. Other aspects and features will become apparent from the following detailed description considered in conjunction with the accompanying drawings and the claims.

### BRIEF DESCRIPTION OF THE FIGURES

FIG. 1 is a system diagram outlining the delivery of video and audio content and event messages to a home in accordance with one embodiment;

FIG. 2 is a system diagram showing further details of a representative set top box receiver in accordance with one embodiment;

FIG. 3 is a diagram depicting a touch panel control device in accordance with one embodiment;

FIG. 4 is a flow diagram depicting representative steps for subscribing to event messages in accordance with one embodiment; and

FIG. 5 is a flow diagram depicting representative steps for receiving and displaying event messages in accordance with one embodiment.

### DETAILED DESCRIPTION

The present principles enable a user to privately monitor event messages, in real time, associated with television channels to which the user has selected to be in a subscription list. In particular, a second screen device is used to receive and display event messages associated with subscribed television channels, except for the subscribed television channel that is currently selected. In this manner the user is able to monitor in real time event messages associated with television channels that he is otherwise interested in, but cannot directly monitor. Additionally, the present principles enables the user to select from the second screen device a new channel from the subscription list, for example, upon seeing an interesting event message, wherein the display of event messages is automatically adjusted to remove the event messages associated with the newly selected television channel and add the event messages associated with the previously selected television channel. The transmission between the second screen device and the message server is performed over a communication network that is different and independent of the transmission network over which the television channel is transmitted. This provides the advantage that the event messages may be stored and transmitted from a source that is distinct and independent of the source of the television channel.

The event messages may comprise, for example, description of the content of the programs transmitted on the television channel as the program progresses in real time. The event messages may also comprise comments about the program posted on social networks by designated friends of the user. The event messages may be generated or aggregated by a company independent of, or affiliated with, the local delivery network company or the content producer. The event messages are stored, or aggregated, on a message server that is configured to communicate with the application on a second screen device.

In summary, a method according to the present principles operates as follows. A user turns on the TV set and STB, and then selects a channel to watch the TV program. The user wants to subscribe and receive event messages for TV programs, and starts the corresponding event message application on the second screen device, for example, a tablet. The event message application automatically detects the current watched TV channel name and transfers the TV channel name to the message servers to find whether or not there are event messages for the channel. If there are event messages related with the TV channel available for subscription and the user hasn't subscribed to it according to the subscription record for the user on the message servers, then the application will pop up a button of “subscribe to the channel's event messages” on its interface to enable the viewer to subscribe to the event messages for the specific channel. On the contrary, if it is detected that the user has subscribed to event messages for the specific TV channel according to the subscription record for the user, then the application will pop up a button of “unsubscribe to the channel's event messages” on its interface to enable the user to unsubscribe to the specific channel's related event messages.

Then the viewer may subscribe to the current watched channel's related event messages by clicking on the “subscribe to the channel's event messages” button on the application's user interface at the tablet, or unsubscribe to the current watched channel's related event messages by clicking on the “unsubscribe to the channel's event messages” button on the application's user interface at the tablet, respectively.

Once being started, the event message application will establish connection with the message servers over, for example, an IP network, and inquire from the subscription record database on the message servers whether or not the user has subscribed event messages for any TV channel. If the record shows the user has active subscription, the message servers will start to send all event messages for these subscribed TV channels, except the messages for the current watched channel no matter whether or not it is subscribed, to event message application at the second screen device, which will then show these messages on its user interface with the example format illustrated as follows in table 1. (Under the condition that the user subscribes to event messages for TV channel 1, 2 and 3 and the current watched channel isn't TV channel 1, 2 or 3).

TABLE 1
User interface showing event messages of TV channel 1, 2 and 3

| | | |
|---|---|---|
| Name of TV channel 1: | Name of TV program: | Event message 1 |
| Name of TV channel 2: | Name of TV program: | Event message 2 |
| Name of TV channel 3: | Name of TV program: | Event message 3 |
| Name of TV channel 1: | Name of TV program: | Event message 4 |
| Name of TV channel 2: | Name of TV program: | Event message 5 |
| Name of TV channel 3: | Name of TV program: | Event message 6 |

After that, the viewer may click on the name of a TV channel to watch event messages only for the specific TV channel. For example, the event message application will show the event messages as follows if the viewer clicks on the “name of TV channel 1” at the interface illustrated in Table 2.

TABLE 2
User interface showing event messages dedicated for TV channel 1

| | | |
|---|---|---|
| Name of TV channel 1: | Name of TV program: | Event message 1 |
| Name of TV channel 1: | Name of TV program: | Event message 2 |
| Name of TV channel 1: | Name of TV program: | Event message 3 |
| Name of TV channel 1: | Name of TV program: | Event message 4 |
| Name of TV channel 1: | Name of TV program: | Event message 5 |
| Name of TV channel 1: | Name of TV program: | Event message 6 |

Then, if the user clicks on the “name of TV channel 1” button on the interface shown in the above table 1 again, the application will instruct the STB to switch to the TV channel 1, either by an external infrared interface or wireless network connection. As soon as the event message application detects the current watched channel has successfully switched to TV channel 1, it will start to show all subscribed event messages again, except the messages for TV channel 1, as shown below in table 3. (Under the condition that the user subscribes to event messages for TV channel 1, 2 and 3 and the current watched channel is TV channel 1)

TABLE 3
User interface showing event messages of TV channel 2 and 3

| | | |
|---|---|---|
| Name of TV channel 2: | Name of TV program: | Event message 1 |
| Name of TV channel 3: | Name of TV program: | Event message 2 |
| Name of TV channel 2: | Name of TV program: | Event message 3 |
| Name of TV channel 3: | Name of TV program: | Event message 4 |
| Name of TV channel 2: | Name of TV program: | Event message 5 |
| Name of TV channel 3: | Name of TV program: | Event message 6 |

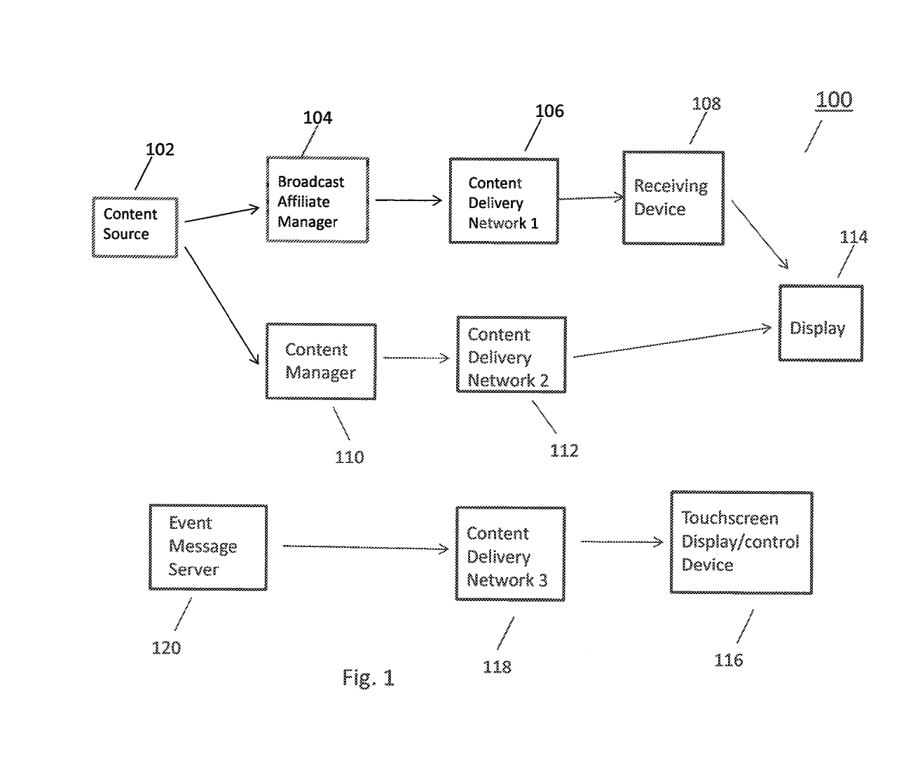

Turning now to FIG. 1, a block diagram of an exemplary embodiment of a system 100 for delivering content to a home or end user is shown. The content originates from a content source 102, such as a movie studio or production source. The content may be supplied to a receiving device 108, such as a set top box, at a customer location in at least one of two forms. One form may be a broadcast form of content. The broadcast content is provided to the broadcast affiliate manager 104, which is typically a national broadcast service, such as the American Broadcasting Company (ABC), National Broadcasting Company (NBC), etc. The broadcast affiliate manager may collect and store the content, and may schedule delivery of the content over a delivery network 106. Delivery network 106 may include satellite link transmission from a national center to one or more regional or local centers. Delivery network 106 may also include local content delivery using local delivery systems such as over the air broadcast, satellite broadcast, or cable broadcast. The locally delivered content is provided to a receiver 108, such as a set top box, located in the customer's home, where the content can be searched and selected by the user. The content is delivered to the home within transmission channels, in a form, such as those specified by Advanced Television Systems Committee (ATSC). The receiving devices are configured to detect system information, such as Program System Information Protocol (PSIP), transmitted by the local broadcaster to detect and acquire programs transmitted on the various television channels. Alternatively, for example, the information for acquiring the channels may be specified by system information defined and transmitted by a local delivery system. It is appreciated that the receiving device 108 can take many forms and may be embodied as a set top box/digital video recorder (DVR), a gateway, a modem, etc. Further, the receiving device 108 may act as entry point, or gateway, for a home network system that includes additional devices configured as either client or peer devices in the home network.

In addition to the system for transmitting and receiving television channels, the present principles also provide for the transmitting and receiving of event information related to programs transmitted on the television channels. Here, the event information is generated, collected, or aggregated within event servers 120 and transmitted via delivery network 118 to receiving devices (touchscreen display/control device) 116. Receiving devices 116 may comprise one of various forms of touch screen display and control devices, including, but not limited to smart phones, tablet computers, and second screen remote control devices.

The receiving device 116 may be adapted to provide user control for the receiving device 108 and/or the display device 114. The receiving device 116 may also be capable of displaying video content. The video content may be graphics entries, such as user interface entries, or may be a portion of the video content that is delivered to the display device 114. The receiving device 116 may interface to receiving device 108 using any well known signal transmission system, such as infra-red (IR) or radio frequency (RF) communications and may include standard protocols such as infra-red data association (IRDA) standard, Wi-Fi, Bluetooth and the like, or any other proprietary protocols. In some embodiments, the receiving device 116 can be interfaced directly with delivery networks 1 and 2. Operations of receiving device 116 will be described in further detail below.

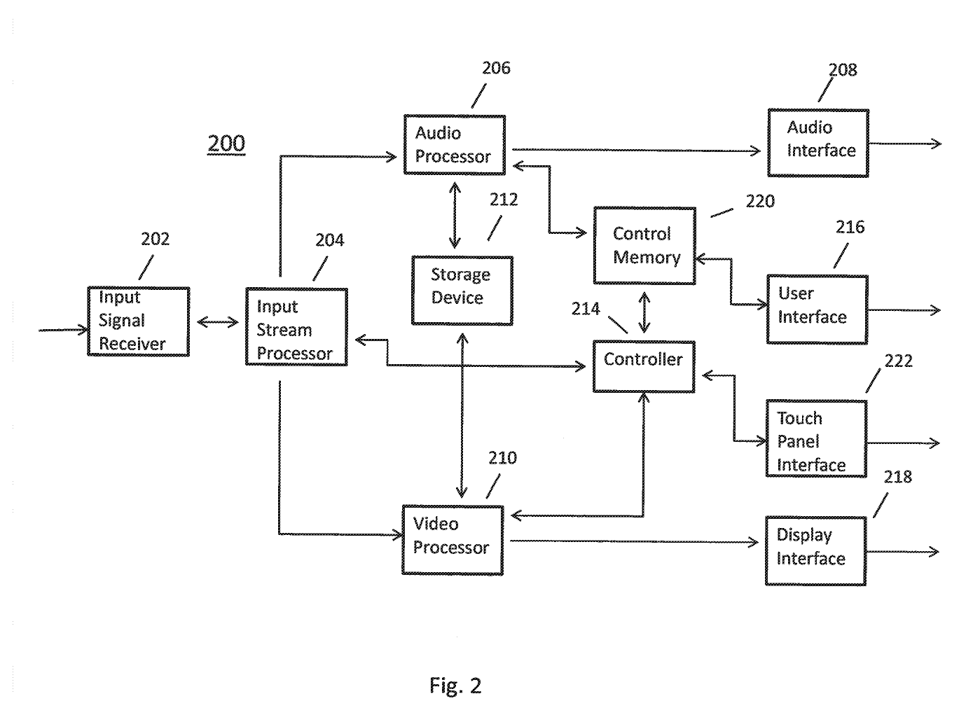

Turning now to FIG. 2, a block diagram of an embodiment of a receiving device 200 is shown. Receiving device 200 may operate similar to the receiving devices described in FIG. 1 and may be included as part of a gateway device, modem, set-top box, or other similar communications device. The device 200 shown may also be incorporated into other systems including an audio device or a display device. In either case, several components necessary for complete operation of the system are not shown in the interest of conciseness, as they are well known to those skilled in the art.

In the device 200 shown in FIG. 2, the content is received by an input signal receiver 202. The input signal receiver 202 may be one of several known receiver circuits used for receiving, demodulation, and decoding signals provided over one of the several possible networks including over the air, cable, satellite, Ethernet, fiber and phone line networks. The desired input signal may be selected and retrieved by the input signal receiver 202 based on user input provided through a control interface or touch panel interface 222. Touch panel interface 222 may include an interface for a touch screen device. Touch panel interface 222 may also be adapted to interface to a cellular phone, a tablet, a mouse, a high end remote or the like.

The decoded output signal is provided to an input stream processor 204. The input stream processor 204 performs the final signal selection and processing, and includes separation of video content from audio content for the content stream. The audio content is provided to an audio processor 206 for conversion from the received format, such as compressed digital signal, to an analog waveform signal. The analog waveform signal is provided to an audio interface 208 and further to the display device or audio amplifier. Alternatively, the audio interface 208 may provide a digital signal to an audio output device or display device using a High-Definition Multimedia Interface (HDMI) cable or alternate audio interface such as via a Sony/Philips Digital Interconnect Format (SPDIF). The audio interface may also include amplifiers for driving one more sets of speakers. The audio processor 206 also performs any necessary conversion for the storage of the audio signals.

The video output from the input stream processor 204 is provided to a video processor 210. The video signal may be one of several formats. The video processor 210 provides, as necessary a conversion of the video content, based on the input signal format. The video processor 210 also performs any necessary conversion for the storage of the video signals.

A storage device 212 stores audio and video content received at the input. The storage device 212 allows later retrieval and playback of the content under the control of a controller 214 and also based on commands, e.g., navigation instructions such as fast-forward (FF) and rewind (Rew), received from a user interface 216 and/or touch panel interface 222. The storage device 212 may be a hard disk drive, one or more large capacity integrated electronic memories, such as static RAM (SRAM), or dynamic RAM (DRAM), or may be an interchangeable optical disk storage system such as a compact disk (CD) drive or digital video disk (DVD) drive.

The converted video signal, from the video processor 210, either originating from the input or from the storage device 212, is provided to the display interface 218. The display interface 218 further provides the display signal to a display device of the type described above. The display interface 218 may be an analog signal interface such as red-green-blue (RGB) or may be a digital interface such as HDMI. It is to be appreciated that the display interface 218 will generate the various screens for presenting the search results in a three dimensional gird as will be described in more detail below.

The controller 214 is interconnected via a bus to several of the components of the device 200, including the input stream processor 202, audio processor 206, video processor 210, storage device 212, and a user interface 216. The controller 214 manages the conversion process for converting the input stream signal into a signal for storage on the storage device or for display. The controller 214 also manages the retrieval and playback of stored content. Furthermore, as will be described below, the controller 214 performs searching of content and the creation and adjusting of the gird display representing the content, either stored or to be delivered via the delivery networks, described above.

The controller 214 is further coupled to control memory 220 (e.g., volatile or non-volatile memory, including RAM, SRAM, DRAM, ROM, programmable ROM (PROM), flash memory, electronically programmable ROM (EPROM), electronically erasable programmable ROM (EEPROM), etc.) for storing information and instruction code for controller 214. Control memory 220 may store instructions for controller 214. Control memory may also store a database of elements, such as graphic elements containing content. The database may be stored as a pattern of graphic elements. Alternatively, the memory may store the graphic elements in identified or grouped memory locations and use an access or location table to identify the memory locations for the various portions of information related to the graphic elements. Additional details related to the storage of the graphic elements will be described below. Further, the implementation of the control memory 220 may include several possible embodiments, such as a single memory device or, alternatively, more than one memory circuit communicatively connected or coupled together to form a shared or common memory. Still further, the memory may be included with other circuitry, such as portions of bus communications circuitry, in a larger circuit.

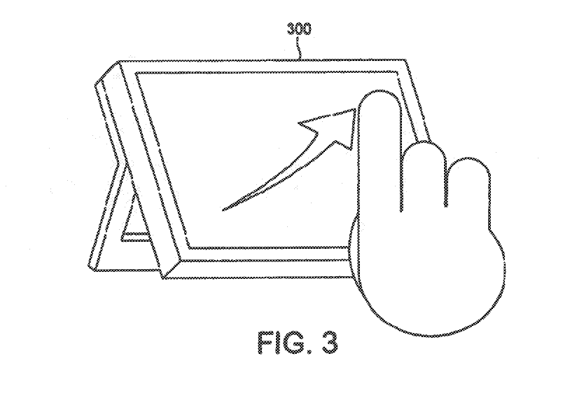

The user interface process of the present principles employs an input device that can be used to express functions, such as fast forward, rewind, etc. To allow for this, a touch panel device 300 may be interfaced via the user interface 216 and/or touch panel interface 222 of the receiving device 200, as shown in FIG. 3. The touch panel device 300 allows operation of the receiving device or set top box based on hand movements, or gestures, and actions translated through the panel into commands for the set top box or other control device. In one embodiment, the touch panel 300 may simply serve as a navigational tool to navigate the gird display. In other embodiments, the touch panel 300 will additionally serve as the display device allowing the user to more directly interact with the navigation through the grid display of content. In either case, the touch panel 300 displays the event messages for the subscribed television channels according to the present principles discussed below. The touch panel device may be included as part of a remote control device containing more conventional control functions such as actuator or activator buttons. The touch panel device is used to enable the user to select the channels to be included in the subscription list, as well as determine which event information associated with which channels should be displayed, and to change the channel being received and processed by receiver 108. The touch panel 300 can also includes at least one camera element. In some embodiments, the touch panel 300 may also include a microphone.

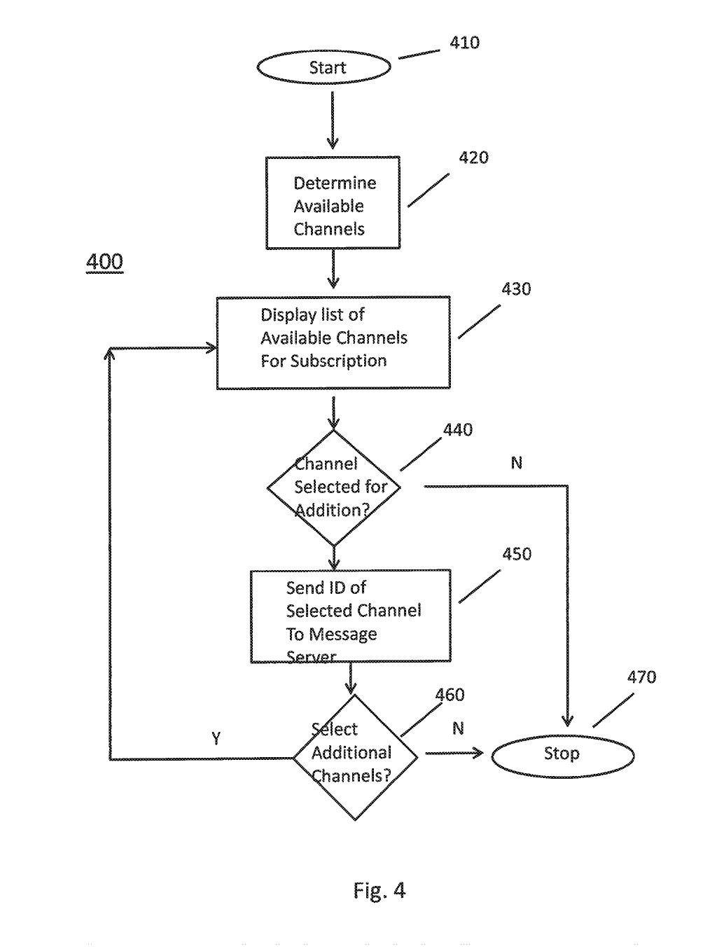

Turning now to FIG. 4 a flowchart showing representative steps for selecting a list of channels for subscription is shown. Starting at step 410, the system first determines the channels that are available for the user at step 420. The channels that are available may be determined based on the location of the user, for example for over the air broadcasts, and a local delivery system that the user may subscribe to, for example, a local cable company or a satellite provider. The listing of available television channels may be determined by running an application stored on the second screen device, for example on a smart phone or one a tablet device. Additionally, the listing of available channels may be received from the receiver device, if the receiver device is configured to transmit this information to the second screen device.

Once the available channels are determined, the listing is displayed on the second screen device in step 430. The listing may be a simple table form. The listing may include all television channels available to the user, and may include an indication of which channels the user has already subscribed to. The indication may be provided by listing the subscribed channels in a different color, or by showing an icon indicative of the subscription next to the channel identification. Alternatively, the listing may remove the channels to which the user has already subscribed. The listing also provides an option for the user to subscribe to a particular channel on the list, for example by providing a “subscribe” button adjacent to the name of the channel.

If the application determines that the user has selected a particular channel on the listing in step 440, the application transmits the channel identifier to the message server via the communications network connecting the second screen device with the message server in step 450. If the user does not select any channels, or additional channels, for subscription, for example by not providing any input for a predetermined time in step 440, the method stops in step 470 and returns to providing event messages as appropriate.

Following step 450, the user may select an option to select additional channels for subscription in step 460. After the channel selection and transmission of channel identification in steps 440 and 450 is confirmed to the user, the user may be provided with the option to provide additional channels for subscription. If the user selects the option to select additional channels for subscription, the application returns to step 430 and provides a listing of the available channels for user selection. In this manner, the application determines the available channels for selection and the user is able to select particular channels for receiving event messages.

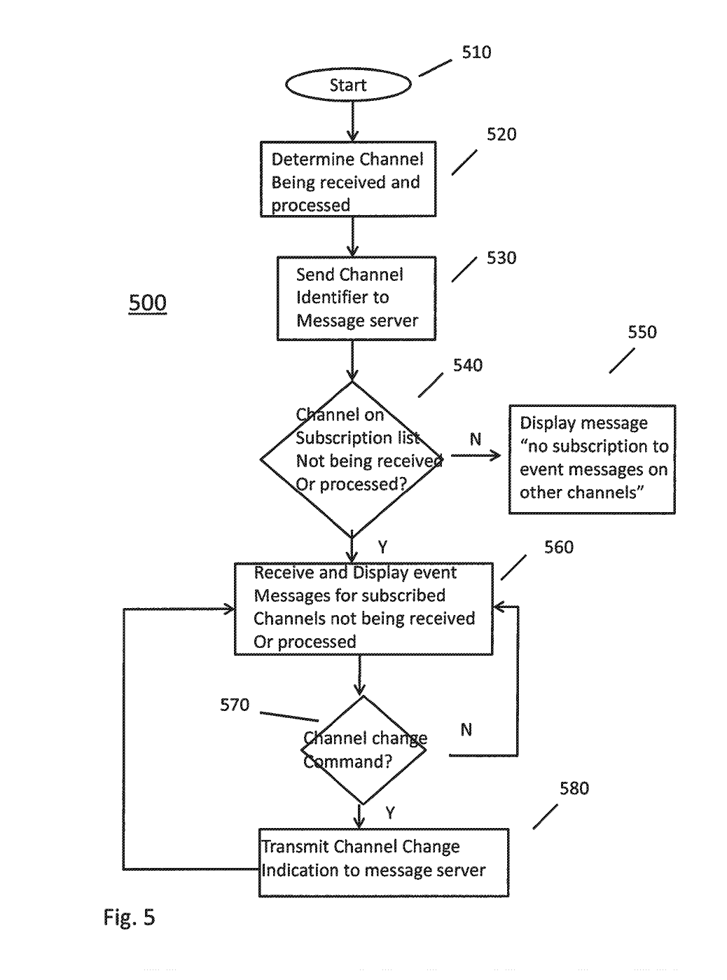

Turning to FIG. 5, there is shown a flowchart showing representative steps for displaying event messages for channels to which a user has subscribed. Starting with step 500, the application first determines which channel is being currently received, processed and displayed on the main display device in step 520. The second screen device may determine the current channel by, for example, analyzing an audio finger print of the television program being displayed, receiving user input of the channel selected for display, or based on a stored history of the channel selections made using the second screen device. Alternatively, the second screen device may receive an indication of the selected channel directly from the television receiver, if the television receiver is configured to transmit such information to the second screen device. Once the second screen device has determined the currently selected television channel, it transmits an identification associated with the currently selected television channel to the message server in step 520.

The second screen device then receives the event messages and displays the event messages associated with the non-selected subscribed television channels. First the second screen device determines whether there are non-selected subscribed television channels in step 530. If so, the second screen device receives and displays the event messages associated with those non-selected subscribed television channels in step 560. If not, the second screen device provides a message that indicates that there are no event messages associated with subscribed channels available for display at this time in step 550.

Although in one embodiment the second screen device transmits the identification of the selected television channel to the message server and subsequently receives the appropriate event messages, the present principles may be embodied in a system in which the second screen device receives the event messages and appropriately filters the messages for display.

Alternatively, the system may be configured so that the second screen device receives all event messages associated with the subscribed available channels. The second screen device then filters the event messages so that only those messages associated with the non-selected subscribed channel are displayed while the selected channel is displayed on the main display device.

Alternatively, the system may be configured so that the second screen device receives all event messages associated with the channels available to the user. The second screen device then filters the event messages so that only those messages associated with the non-selected subscribed channels are displayed while the selected channel is being displayed on the main display device.

Furthermore, once the second screen device begins to display the event messages associated with all of the non-selected subscribed channels, the user may be provided with an option to further select channels from that list and only display event messages associated with the further selected channels.

Furthermore, the second screen device may be used as a remote control device for controlling the television receiver device as shown in step 570. For example, the second screen device may include an IR or RF transmitter, and capable of acquiring, via the Internet other appropriate networks, and storing remote control codes associated with the television receiver device so that the user can, for example, change the television channel using the second screen device. In one embodiment, the second screen device displays the event messages for non-selected subscribed television channels along with respective icons adjacent to the messages, wherein the second screen device transmits a channel change command to the television receiver when the user selects an icon.

Once the user changes the selected television channel, the application automatically recognizes the channel change, by for example, user input on the second screen device or analysis of the audio fingerprint, and changes the display of the event messages. Specifically, the second screen display no longer displays the event messages associated with the newly selected television channel and begins to display the event messages associated with the previously selected television channel along with the event messages of the other non-selected television channels. In this manner the second screen device enable the user to privately monitor event messages associated with all of the other non-selected subscribed television channels. In one embodiment the second screen device transmits the identification of the newly selected channels to the message server as in step 580, receives the appropriate event messages, and displays these appropriate event messages as in step 560. Again, the receipt, filtering and display of the event messages may be performed using the alternative methods mentioned above.

Although exemplary embodiments of the present principles have been described hereinabove, it is clear that alternative embodiments are possible and would be contemplated by those skilled in the art in view of the teachings hereinabove. Multiple subscription accounts may be registered within the application so that a user can easily select a subscription account that is suitable for particular viewing situations or time. For example, one subscription account may includes sports channels, while another may include news channels so that the user can monitor just the channel having the subject they are interested in at the moment. Additionally, the subscription accounts may be tied to particular individuals so that the subscribed television channels are appropriate for the viewer, for example children shows only. The subscription accounts may be controlled by someone having administrator authority so that only designated television channels can be included within certain subscription channels and modification to the subscription list can only be made with administrator approval. The application may also provide for exchanging subscription channels with other users, for example, via social networks. In an embodiment, the application may receive a notification by a friend of the user recommending certain channels to the included in the subscription. By accepting the recommendation, the application automatically adds the recommended channels to the user's subscription list.

All examples and conditional language recited herein are intended for pedagogical purposes to aid the read in understanding the principles of the invention and the concepts contributed by the inventor to furthering the art and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be understood that the present principles may be implemented in various forms of hardware, software, firmware, special purpose processors, or a combination thereof. Preferably, the present principles may be implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) that is executed via the operating system. In addition, various other peripheral devices may be connected to the computer platform such as an additional data storage device and a printing device.

It is to be further understood that, because some of the constituent system components and method steps depicted in the accompanying Figures are preferably implemented in software, the actual connections between the system components (or the process steps) may differ depending upon the manner in which the present principles is programmed. Given the teachings herein, one of ordinary skill in the related art will be able to contemplate these and similar implementations or configurations of the present principles.

While there have been shown, described and pointed out fundamental novel features of the present principles, it will be understood that various omissions, substitutions and changes in the form and details of the methods described and devices illustrated, and in their operation, may be made by those skilled in the art without departing from the spirit of the same. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or implementation of the present principles may be incorporated in any other disclosed, described or suggested form or implementation as a general matter of design choice. It is the intention, therefore, to be limited only as indicated by the scope of the claims appended hereto.

1. A method for displaying event messages, comprising:
subscribing to receive event messages associated with one or more television channels;
determining a current television channel being received and displayed;
receiving and displaying event messages associated with subscribed television channels other than the current television channel, wherein the event messages are displayed on a display screen other than a screen displaying the current television channel.

2. The method of claim 1, wherein the receiving and displaying step comprises receiving the event messages via a transmission channel that is separate from the transmission channel associated with the television channels.

3. The method of claim 1, wherein the subscribing step comprises selection one of a plurality of subscription lists, each of the subscription lists including a list of subscribed television channels.

4. The method of claim 1, wherein the subscribing step comprises accepting a subscription list including a list of subscribed television channels recommended by a friend in a social network.

5. The method of claim 1, wherein the subscribing step comprises
displaying a list of possible television channels for subscription, receiving user input of selected ones of the possible television channels, and transmitting the user selected ones of the possible television channels to a message server.

6. The method of claim 5, wherein the determining step comprises
receiving an indication of the current television channel from a television receiver.

7. The method of claim 5, wherein the determining step comprises
using an audio signature of a program on the current television channel to determine the current television channel.

8. The method of claim 5, wherein the receiving and displaying step comprises receiving and displaying real time event messages indicative of current program events transmitted on the current television channel.

9. The method of claim 5, wherein the receiving and displaying event messages is performed on one of a smart phone, tablet computer and remote control device.

10. The method of claim 5, further comprising
providing a user input display enabling selection of the subscribed television channels other than the current television channels, and upon selection of one of these channels, transmitting a control signal to cause the television receiver to receive and process the selected television channel.

11. The method of claim 5, wherein the receiving and displaying step comprises receiving the event messages from one of broadcasters associated with the television channels, event message production entity, and social networks.

12. An apparatus for displaying event messages, comprising:
means for determining a current television channel being received and displayed by a separate television receiver and display;
means for subscribing to receive event messages associated with one or more television channels;
means for receiving and displaying event messages associated with subscribed television channels other than the current television channel.

13. The apparatus of claim 12, wherein the receiving and displaying means receives the event messages via a transmission channel that is separate from the transmission channel associated with the television channels.

14. The apparatus of claim 12, wherein the subscribing means includes means for displaying a plurality of subscription lists, each of the subscription lists including a list of subscribed television channels, and receiving user selection of one of the plurality of subscription lists.

15. The apparatus of claim 12, wherein the subscribing means includes means for accepting a subscription list including a list of subscribed television channels recommended by a friend in a social network.

16. The apparatus of claim 12, wherein the subscribing means includes means for displaying a list of possible television channels for subscription, receiving user input of selected ones of the possible television channels, and transmitting the user selected ones of the possible television channels to a message server.

17. The apparatus of claim 16, wherein the determining means receives an indication of the current television channel from a television receiver.

18. The apparatus of claim 16, wherein the determining means determines the current television channel by using an audio signature of a program on the current television channel to determine the current television channel.

19. The apparatus of claim 16, wherein the apparatus comprises one of a smart phone, tablet computer and remote control device.

20. The apparatus of claim 16, wherein the receiving means comprises means for receiving the event messages from one of broadcasters associated with the television channels, event message production entity, and social networks.
